(19) United States
(12) Patent Application Publication
(10) Pub. No.: US 2025/0382024 A1
(43) Pub. Date: Dec. 18, 2025

(54) WHEEL WITH INTEGRAL, LUBRICANT-FILLED HUB

(71) Applicant: Terra Drive Systems, Inc., Brookston, IN (US)

(72) Inventors: Daniel Skelton, West Lafayette, IN (US); Lane C. Kirby, West Point, IN (US)

(73) Assignee: Terra Drive Systems, Inc., Brookston, IN (US)

(21) Appl. No.: 19/211,935

(22) Filed: May 19, 2025

Related U.S. Application Data
(60) Provisional application No. 63/659,872, filed on Jun. 14, 2024.

(51) Int. Cl. B62D 55/092; B62D 55/15

(52) U.S. Cl. CPC B62D 55/092; B62D 55/15

(57) ABSTRACT

The present invention is directed to a wheel which is adapted to be rotatably mounted on an axle. The wheel comprises a central hub, a rim which circumscribes the central hub, and a plurality of spokes which extend between and connect the central hub and the rim. The central hub, the rim, and the plurality of spokes are integrally formed as a single, unitary piece. The central hub comprises an axle bore and a lubricant reservoir. The axle bore is adapted to receive the axle for rotatably mounting the wheel thereto. The lubricant reservoir is formed within the central hub and includes an opening which opens into the axle bore. As the wheel rotates, the lubricant flows through the opening into the axle bore and lubricates the axle. Preferably, the central hub includes agitating fins located within the lubricant reservoir which agitate and circulate the lubricant as the wheel rotates.

### CROSS REFERENCE TO RELATED APPLICATION

This application claims priority under 35 U.S.C. 119 (e) of U.S. provisional patent application Ser. No. 63/659,872 filed on Jun. 14, 2024, entitled Wheel with Integral, Lubricant-Filled Hub, the disclosure of which is hereby incorporated herein by reference.

### BACKGROUND OF THE INVENTION

### 1. Field of the Invention

The present invention relates to wheels used in land vehicles. More particularly, the present invention is directed to a wheel having an integrally formed hub which is filled with a lubricant.

### 2. Background

Many land vehicles include one or more wheels which provide a rolling surface for movement of the vehicle. Generally, these wheels are mounted on hubs which are rotatably coupled to the axles of the vehicle. However, some wheels include integrally formed hubs which allow the wheels to be mounted directly to an axle. Integrally forming the wheel and hub together significantly improves the strength and structural integrity of the wheel, which is particularly valuable for wheels used in high-load applications such as, for example, the wheels used in continuous track assemblies to support the endless belts thereof.

Traditionally, wheels having integral hubs are manufactured in two separate halves which are secured together to form a single wheel. Examples of such wheels are shown and described in Albright et al., U.S. Pat. No. 2,990,216; Moyer, U.S. Pat. No. 2,998,282, Eaton, U.S. Pat. No. 3,871,709; Scelsi et al., U.S. Pat. No. 7,369,966; Hamilton, U.S. Pat. No. 8,186,767; and Zeisler, U.S. Pat. No. 10,350,940.

However, assembling these two-part wheels is time consuming. Additionally, these traditional wheels typically use tapered roller bearings which are lubricated by grease which is packed into the bearing and must be periodically replaced. This process is also time consuming and, if done incorrectly, can reduce the service life of the bearings. Accordingly, there exists a need for an improved wheel having an integrally formed hub.

### SUMMARY OF THE INVENTION

In one form thereof, the present invention is directed to a wheel which is adapted to be rotatably mounted on an axle. The wheel comprises a central hub, a rim which circumscribes the central hub, and a plurality of spokes which extend between and connect the central hub and the rim. The central hub, the rim, and the plurality of spokes are integrally formed as a single, unitary piece. The central hub comprises an axle bore and a lubricant reservoir. The axle bore is adapted to receive the axle for rotatably mounting the wheel thereto. The lubricant reservoir is formed within the central hub and includes an opening which opens into the axle bore. As the wheel rotates, the lubricant flows through the opening into the axle bore and lubricates the axle.

Preferably, the central hub further comprises a plurality of agitating fins located within the lubricant reservoir. As the wheel rotates, the agitating fins agitate and circulate the lubricant within the lubricant reservoir. Yet more preferably, the agitating fins are triangle-shaped and comprise a thickened base portion.

Preferably, the lubricant reservoir comprises a cylindrical perimeter surface, an annular outboard end surface, an annular inboard end surface, and one or more triangular agitating fins which extend between the cylindrical perimeter surface and either the annular inboard end surface or the annular outboard end surface. Yet more preferably, one or more of the triangular agitating fins comprises a thickened base portion.

Preferably, the axle comprises a cylindrical inboard axle bearing surface and a cylindrical outboard axle bearing surface and the axle bore comprises a cylindrical inboard hub bearing surface and a cylindrical outboard hub bearing surface. In use, the cylindrical inboard hub bearing surface slidingly engages the cylindrical inboard axle bearing surface and the cylindrical outboard hub bearing surface slidingly engages the cylindrical outboard axle bearing surface.

Preferably, the axle bore is sized such that narrow gaps are formed between the cylindrical hub bearing surfaces and the cylindrical axle bearing surfaces. As the wheel rotates, the lubricant flows through the axle bore into the narrow gaps for lubricating the cylindrical hub bearing surfaces and the cylindrical axle bearing surfaces.

Preferably, the wheel further comprises a pair of bearings. The bearings are secured to the axle and are received into and engage the axle bore for rotatably coupling the wheel to the axle. As the wheel rotates, lubricant flows through the axle bore to the bearings. Preferably, the bearings are open-type tapered roller bearings.

Preferably, the wheel further comprises a hub cap. The axle bore comprises an outboard end and the hub secures to the central hub and encloses the axle bore outboard end. Preferably, the hub cap is a cup-shaped member comprising a mounting flange, a cylindrical perimeter wall, a cap end wall, and a cap reservoir defined within the hub cap between the cap end wall and the cylindrical perimeter wall. The mounting flange secures to the central hub and lubricant flows between the lubricant reservoir and the cap reservoir through the axle bore.

Preferably, the cap end wall is constructed from a transparent material such that the condition and volume of the lubricant is visible through the cap end wall.

Preferably, the wheel further comprises an annular gasket. The axle bore comprises an inboard end and the annular gasket engages the axle and the central hub and seals the axle bore inboard end.

Preferably, the lubricant is an oil-based lubricant or a grease-based lubricant.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of an agricultural trailer having a pair of continuous tracks;

FIG. 2 is a side elevation view of a continuous track having a plurality of wheels;

FIG. 3 is a perspective view of a wheel shown in FIG. 2, said wheel having an integral hub;

FIG. 4 is a side elevation view of the wheel shown in FIG. 3;

FIG. 5 is a section view of the wheel taken along the line 5-5 shown in FIG. 4;

FIG. 6 is a perspective view showing the internal structure of the wheel, wherein the wheel has been cut in half along the line 5-5 shown in FIG. 4;

FIG. 7 is another perspective view showing the other half of the wheel shown in FIG. 6;

FIG. 8 is a perspective view of the wheel shown in FIG. 3 having a hub cap secured thereto;

FIG. 9 is a side elevation view of the wheel shown in FIG. 8;

FIG. 10 is section view of the wheel taken along the line 10-10 shown in FIG. 9, wherein the hub of the wheel directly mounts to the axle;

FIG. 11 is section view of the wheel taken along the line 10-10 shown in FIG. 9, wherein the wheel is mounted on bearings which secure to the axle;

FIG. 12 is an exploded perspective view of the wheel shown in FIGS. 8-11;

FIG. 13 is an exploded section view of the wheel shown in FIG. 12 taken along the line 10-10 shown in FIG. 9;

FIG. 14 is a partially exploded perspective view of the wheel wherein the components of the hub cap are shown in an exploded state;

FIG. 15 is an exploded section view of the wheel shown in FIG. 14 taken along the line 10-10 shown in FIG. 9.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

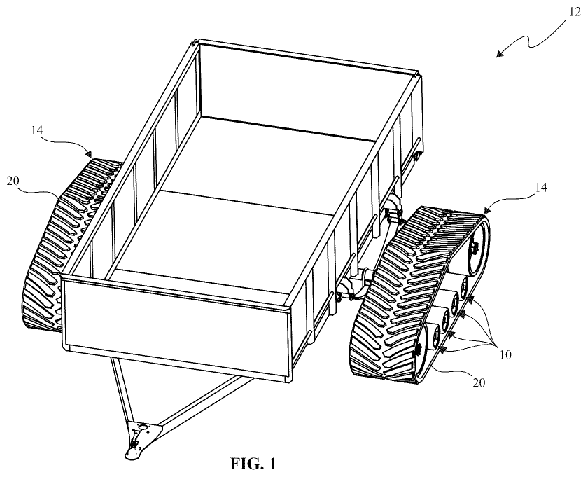

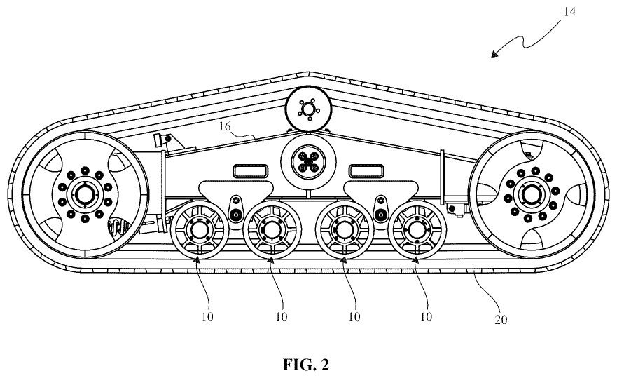

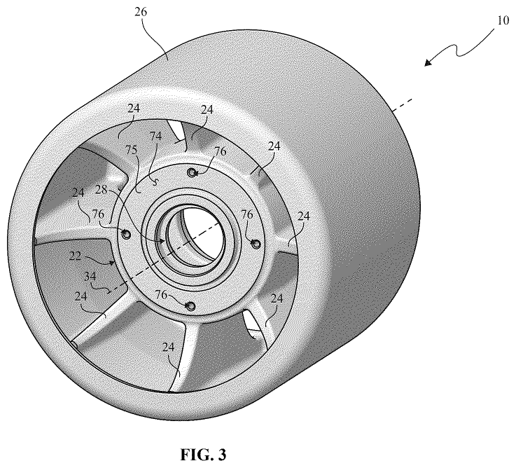

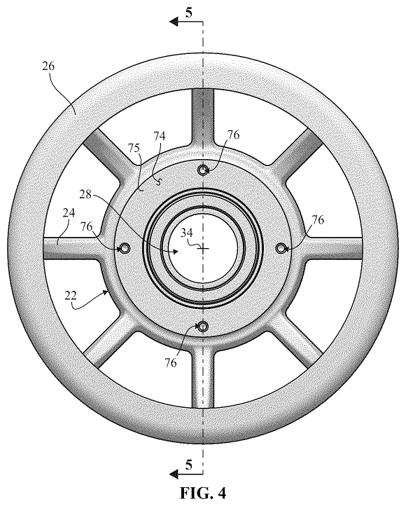

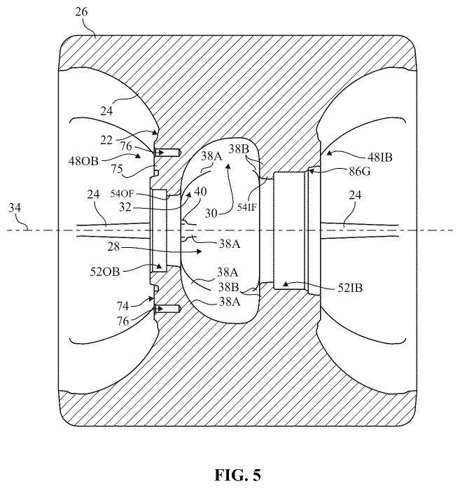

Referring initially to FIGS. 1-7, a unitary wheel constructed in accordance with the principles of the present invention is shown and generally designated by the numeral 10. The wheel 10 is adapted to be rotatably mounted on the axle of a land vehicle, such as, for example, an agricultural trailer 12. More particularly, the agricultural trailer 12 can include a pair of continuous tracks 14 having frames 16 with axles 18 secured thereto. One or more wheels 10 can be rotatably mounted on the axles 18 with the endless belts 20 of the continuous tracks 12 entrained around and supported by the wheels 10.

The wheel 10 comprises a central hub 22, a plurality of spokes 24, and a barrel-shaped rim 26 which are integrally formed together as a single, unitary piece. The central hub 22 is generally cylindrical and comprises an axle bore 28 and a lubricant reservoir 30. The axle bore 28 extends longitudinally through the central hub 22 and is adapted to receive an axle 18 for rotatably mounting the wheel 10 thereto. The lubricant reservoir 30 is a doughnut-shaped cavity which is formed within the central hub 22 and circumscribes the axle bore 28. The lubricant reservoir 30 is adapted to store a volume of lubricant and includes an opening 32 which allows the lubricant to flow between the lubricant reservoir 30 and the axle bore 28. As the wheel 10 rotates, the lubricant flows through the opening 32 into the axle bore 28 and provides lubrication for the wheel 10 and the axle 18. Preferably, the lubricant is an oil or a grease-based lubricant.

The barrel-shaped rim 26 circumscribes the central hub 22 and forms the exterior load bearing portion of the wheel 10 which engages the endless belt 20 of the continuous track 12. In use, the wheel 10 rotates around a central longitudinal wheel axis 34 which extends longitudinally through the center of the axle 18. Preferably, the central hub 22 and the barrel-shaped rim 26 are aligned coaxially with each other and are aligned coaxially with the central longitudinal wheel axis 34 to balance the wheel 10 and prevent vibrations caused by eccentric rotating mass.

The spokes 24 are support members which extend between and connect the central hub 22 to the rim 26 such that forces and impacts experienced by the rim 26 are transferred to the axle 18 through the spokes 24 and the central hub 22. The spokes 24 can be, for example, trapezoidal, plate-shaped members that extend radially between central hub 22 and the barrel-shaped rim 26. Preferably, the spokes 24 are provided at regular, circumferential intervals around the wheel axis 34 in order to maintain the rotating balance of the wheel 10.

The lubricant reservoir 30 comprises a cylindrical perimeter surface 36P, an annular inboard end surface 36IS, an annular outboard end surface 36OS, and one or more agitating fins 38. The agitating fins 38 are adapted to agitate and circulate the lubricant within the lubricant reservoir 30 and the axle bore 28, which helps distribute the lubricant to the bearing structures of the wheel 10 and dissipates heat generated when the wheel 10 is subjected to heavy load cycling. The agitating fins 38 also act like gussets which reinforce the central hub 22 and increase the strength and structural rigidity of the wheel 10.

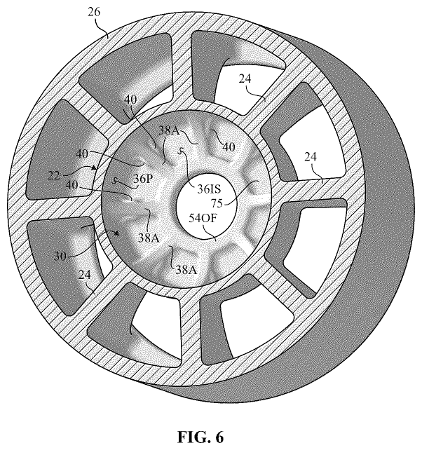

Preferably, as best seen in FIG. 6, the lubricant reservoir 30 comprises a first plurality of agitating fins 38A which extend between the outboard end surface 360S and the perimeter surface 36P. The agitating fins 38A can be formed in multiple shapes and sizes and can be provided in various numbers and at various intervals within the lubricant reservoir 30 as necessary or desired. For example, the agitating fins 38A can be triangle-shaped ribs which extend radially relative to the wheel axis 34 and are provided at regular circumferential intervals around the wheel axis 34.

Preferably, the agitating fins 38A include a thickened base portion 40 which extends along edge formed between the fin 38A and the outboard end surface 360S. As will be discussed below, the central hub 22 can include a plurality of fastener bores 76 which extend into an annular cap mounting surface 74. The annular cap mounting surface 74 and the annular outboard end surface 36OS are located opposite each other and define an outboard hub wall 75 therebetween. The fastener bores 76 extend through the outboard hub wall 75 into the agitating fin thickened base portions 40 which are sized such that a minimum thickness of material is maintained between fastener bores 76 and the lubricating reservoir 30. This ensures that the fastener bores 76 do not create weak points in the central hub 22 which could potentially fail when the wheel 10 is subjected to heavy load cycling.

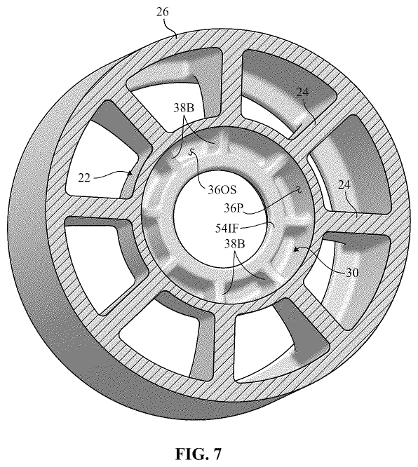

As best seen in FIG. 7, the lubricant reservoir 30 preferably also includes a second plurality of agitating fins 38B. The agitating fins 38B are rectangle-shaped ribs which extend along the reservoir inboard end surface 36IS and the reservoir perimeter surface 36P. The agitating fins 38B also extend radially relative to the wheel axis 34 and are provided at regular circumferential intervals around the wheel axis 34, but, unlike the agitating fins 38A, the agitating fins 38B do not include thickened base portions.

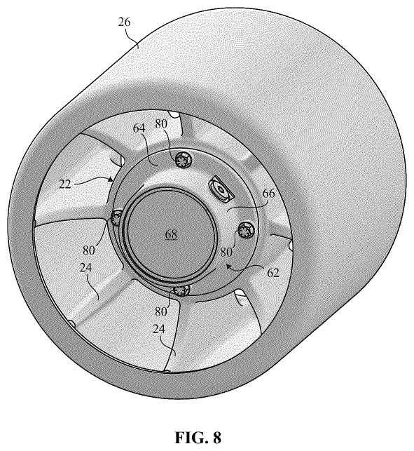

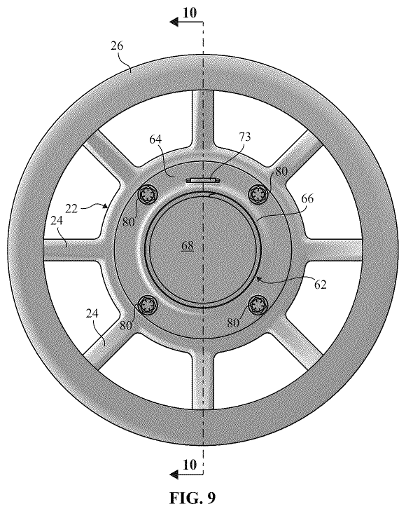

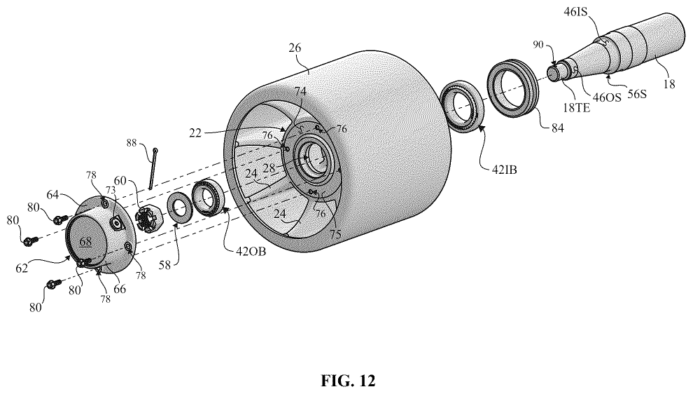

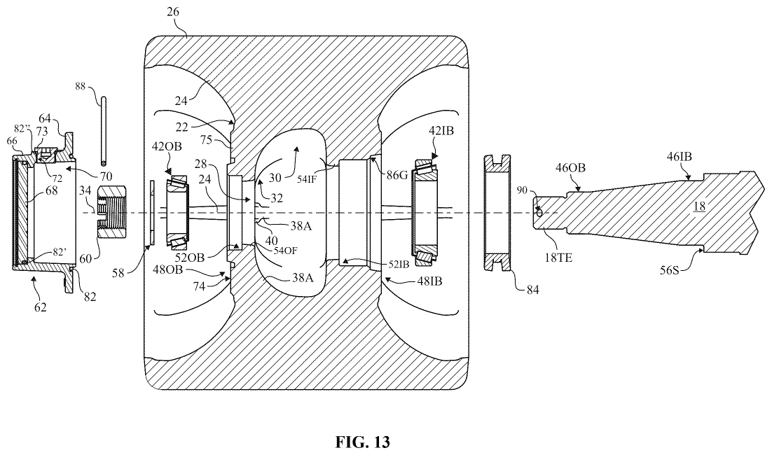

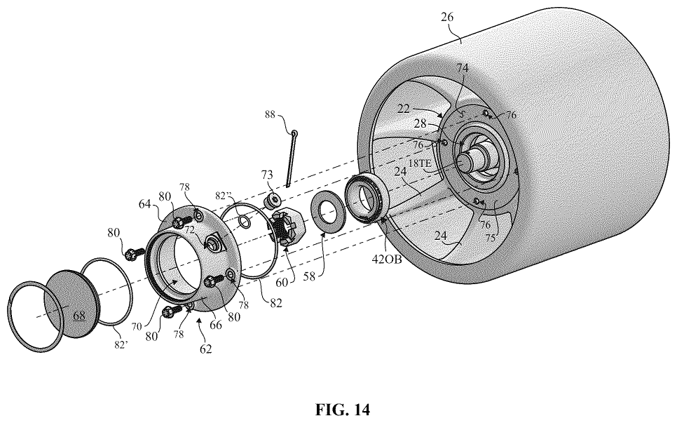

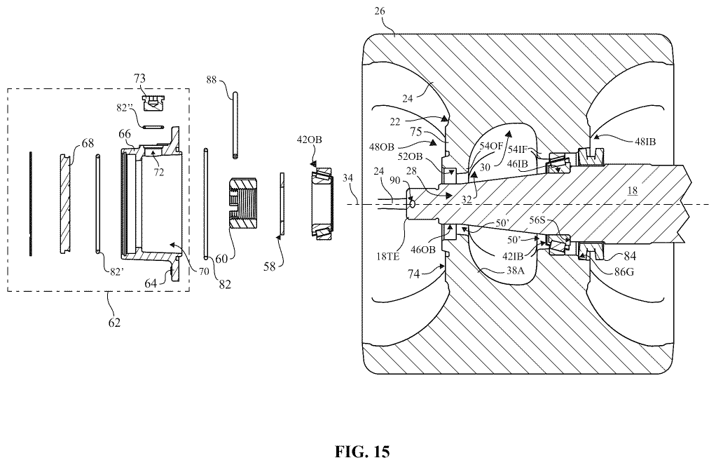

Turning to FIGS. 8-15, as mentioned above, the axle bore 28 extends longitudinally through the central hub 22 and is adapted to receive the axle 18 for rotatably mounting the wheel 10 thereto. Specifically, the wheel 10 can be mounted directly on the axle 18 or the wheel 10 can be rotatably mounted on a pair of bearings 42IB, 420B which are secured to the axle 18.

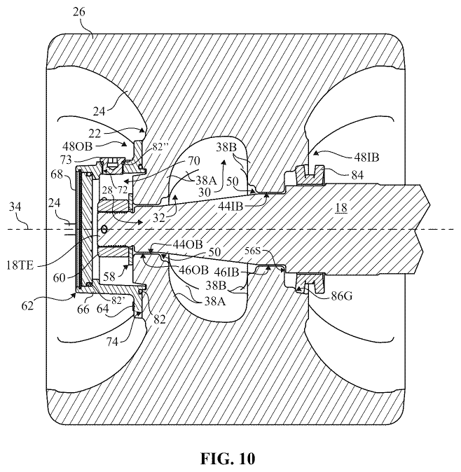

In the first embodiment (FIG. 10), the axle bore 28 comprises a pair of cylindrical inboard and outboard hub bearing surfaces 44IB, 440B and the axle 18 comprises a pair of cylindrical inboard and outboard axle bearing surfaces 46IB, 46OB. The inboard hub bearing surface 44IB is located adjacent the longitudinally inboard end 48IB of the central hub 22 and is adapted to slidingly engage the inboard axle bearing surface 46IB. The outboard hub bearing surface 44OB is located adjacent the longitudinal outboard end 48OB of the central hub 22 and is adapted to slidingly engage the outboard axle bearing surface 460B.

Preferably, the axle 18 and the axle bore 28 are sized such that a narrow gap 50 is formed between the hub bearing surfaces 44IB, 44OB and the axle bearing surfaces 46IB, 46OB. In use, the lubricant stored within the lubricant reservoir 30 flows through the axle bore 28 into the gap 50 and lubricates the bearing surfaces 44IB, 44OB, 46IB, 46OB, thereby reducing friction between the bearing surfaces and reducing wear-and-tear on the hub 22 and the axle 18.

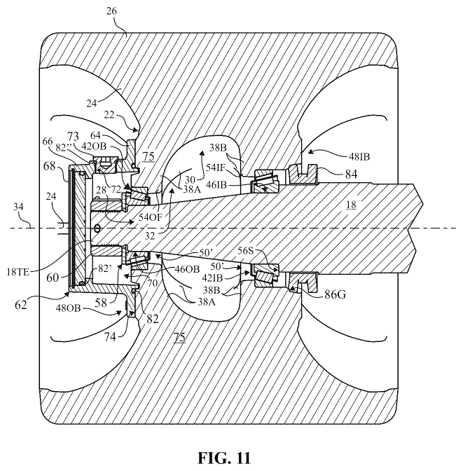

In the second embodiment (FIGS. 11-15), the wheel 10 is rotatably mounted on a pair of bearings comprising an inboard bearing 42IB and an outboard bearing 42OB. The inboard bearing 42IB is sized to fit over the axle 18 and slidingly engages the cylindrical inboard axle bearing surface 46IB. The outboard bearing 42OB is sized to fit over the terminal end 18TE of the axle 18 and slidingly engages the outboard axle bearing surface 46OB. Preferably, the bearings 42IB, 42OB are open-type tapered roller bearings having openings through which the lubricant can enter the bearing races and lubricate the bearing rollers.

The axle bore 28 comprises an inboard bearing socket 52IB which is formed adjacent the longitudinally inboard end 48IB of the central hub 22, and an outboard bearing socket 52OB which is formed adjacent the longitudinally outboard end 48OB of the central hub 22. The inboard bearing socket 52IB is adapted to receive and engage the inboard bearing 42IB and includes an inboard abutment flange 54IF which extends radially inwardly along the circumferential outboard edge of the inboard bearing socket 52IB. The outboard bearing socket 52OB is adapted to receive and engage the outboard bearing 42OB and includes an outboard abutment flange 54OF which extends radially inwardly along the circumferential inboard edge of the outboard bearing socket 52OB. The inboard and outboard abutment flanges 54IF, 54OF are sized such that gaps 50′ are formed between the flanges and the axle 18. These gaps 50′ allow the lubricant to flow through the axle bore 28 to the bearings 42IB, 42OB.

In use, the wheel 10 is mounted on the axle 18 by sliding the inboard bearing 42IB over and along the axle 18 until the inboard bearing 42IB engages the inboard axle bearing surface 46IB. Preferably, the axle 18 includes an inboard abutment shoulder 56S which extends radially outwardly along the circumferential inboard edge of the inboard axle bearing surface 46IB and the inboard bearing 42IB is positioned against/abutting the inboard abutment shoulder 56S.

Next, the wheel 10 is installed with the axle 18 extending through the axle bore 28. As the wheel 10 is installed onto the axle 18, the inboard bearing 42IB is received into the inboard bearing socket 52IB and is sandwiched between the inboard abutment flange 54IF and the inboard abutment shoulder 56S. Then, the outboard bearing 42OB is fitted over the axle terminal end 18TE and is received into outboard bearing socket 52OB whereat the outboard bearing 42OB engages the outboard abutment flange 54OF.

After the wheel 10 and the bearings 42IB, 42OB have been installed onto the axle 18, a thrust washer 58 is fitted over the axle terminal end 18TE and sandwiches the outboard bearing 42OB against the outboard abutment flange 54OF. As should now be appreciated, the bearings 42IB, 42OB and the abutment flanges 54IF, 54OF, and, hence, the wheel 10, form a longitudinal stack which is sandwiched between the axle inboard abutment shoulder 56S and the thrust washer 58. Preferably, the axle terminal end 18TE is threaded such that a lock nut 60 can be threaded onto the axle terminal end 18TE and rotatingly tightened against the nut against the thrust washer 58 for clampingly securing the bearings 42IB, 42OB and the wheel 10 to the axle 18. The lock nut 60 can then be secured in place by a lock pin 88 which is received into a lock pin bore 90 formed in the axle terminal end 18TE.

Preferably, the wheel 10 further includes a hub cap 62 which secures to the central hub 22 and covers/encloses axle terminal end 18TE and the outboard end of the axle bore 28. The hub cap 62 comprises an annular mounting flange 64, a cylindrical perimeter wall 66 which extends perpendicularly from the mounting flange 64, and a cap end wall 68 which encloses the end of the perimeter wall 66 opposite the mounting flange 64. A cap reservoir 70 is formed between cylindrical perimeter wall 66 and the cap end wall 68 and opens through the mounting flange 64. The cap reservoir 70 is adapted to be filled with lubricant with the bearings 42IB, 42OB partially submerged therein.

The mounting flange 64 is adapted to be secured to an annular cap mounting surface 74 which forms the outboard end surface of the central hub 22. Specifically, as mentioned above, the central hub 22 preferably includes a plurality of threaded fastener bores 76 which extend into the cap mounting surface 74. The mounting flange 64 includes corresponding mounting flange bores 78 which align with the fastener bores 76 such that the hub cap 62 can be secured to the central hub 22 using fasteners 80, such as, for example, bolts, which extend through the mounting flange bores 78 and threadingly engage the fastener bores 76.

As mentioned above, the hub cap 62 encloses the outboard end of the axle bore 28. This prevents the lubricant stored within the lubricant reservoir from leaking out of the hub 22 through the outboard bearing 42OB. The wheel 10 can also include an O-ring 82, or other types of gaskets or seals (not shown), which is adapted to be sandwiched between the mounting flange 64 and the cap mounting surface 74 and seals any gaps therebetween for preventing the lubricant from leaking out of the central hub 22.

Preferably, the perimeter wall 66 includes a lubricant fill port 72 which extends through the perimeter wall 66 into the cap reservoir 70 and a port plug 73. The lubricant fill port 72 can be used to fill the lubricant reservoir 30, the axle bore 28, and the cap reservoir 70 with lubricant. The port plug 73 is adapted to engage the lubricant fill port 72 and is used together with an O-ring 82′ to seal the port 72 once the lubricant reservoir 30, the axle bore 28, and the cap reservoir 70 are filled.

Preferably, the cap end wall 68 is manufactured separately from the annular mounting flange 64 and the cylindrical perimeter wall 66, which are integrally formed together as a unitary piece. The cap end wall 68 is adapted to be secured to and encloses the outboard end of the cylindrical perimeter wall 66 opposite the annular mounting flange 64. An O-ring 82″ can be sandwiched between the cap end wall 68 and the cylindrical perimeter wall 66 to seal any gaps therebetween and prevent any lubricant from leaking past the cap end wall 68. Preferably, the cap end wall 68 is constructed from a transparent material, such as, for example, acrylic, Lexan, polycarbonate, and other transparent polymers, such that the condition and volume of the lubricant can view readily viewed through the cap end wall 68.

Preferably, the wheel 10 further comprises an annular gasket 84. The gasket 84 fits over the axle 18 and engages an inboard hub gasket seal surface 86G which is located inboard of the inboard bearing socket 52IB. The gasket 84 seals against the hub gasket seal surface 86G and the axle 18 for preventing the lubricant from leaking out of the inboard end of the axle bore 28 through the inboard bearing 42B.

While this invention has been described as having an exemplary design, the present invention may be further modified within the spirit and scope of this disclosure. This application is therefore intended to cover any variations, uses, or adaptations of the invention using its general principles.

Preferably, except as otherwise set forth herein, the components of the wheel 10 are formed from a rigid, high-strength material such as, for example, steel, aluminum, or other high-strength metals. Preferably, except as otherwise set forth herein, the components of the wheel 10 are formed by casting, molding, machining, or otherwise shaping or forming from a unitary material.

What is claimed is:

1. A wheel adapted to be rotatably mounted on an axle, the wheel comprising:
a central hub comprising:
an axle bore which receives the axle for rotatably mounting the wheel thereto; and
a lubricant reservoir which is formed within the central hub, said lubricant reservoir having an opening which opens into the axle bore;
a rim which circumscribes the central hub;
a plurality of spokes which extend between and connect the central hub and the rim; and
a volume of lubricant which is stored within the lubricant reservoir;
wherein the central hub, the rim, and the plurality of spokes are integrally formed as a single, unitary piece; and
wherein as the wheel rotates, the lubricant flows through the opening into the axle bore and lubricates the axle.

2. The wheel of claim 1, wherein the central hub further comprises a plurality of agitating fins located within the lubricant reservoir, and wherein, as the wheel rotates, the agitating fins agitate and circulate the lubricant within the lubricant reservoir.

3. The wheel of claim 2, wherein the agitating fins are triangle-shaped and comprise a thickened base portion.

4. The wheel of claim 1, wherein the lubricant reservoir comprises a cylindrical perimeter surface, an annular outboard end surface, an annular inboard end surface, and one or more triangular agitating fins which extend between the cylindrical perimeter surface and either the annular inboard end surface or the annular outboard end surface.

5. The wheel of claim 4, wherein one or more of the triangular agitating fins comprises a thickened base portion.

6. The wheel of claim 1, wherein the axle comprises a cylindrical inboard axle bearing surface and a cylindrical outboard axle bearing surface, wherein the axle bore comprises a cylindrical inboard hub bearing surface and a cylindrical outboard hub bearing surface, and wherein the cylindrical inboard hub bearing surface slidingly engages the cylindrical inboard axle bearing surface and the cylindrical outboard hub bearing surface slidingly engages the cylindrical outboard axle bearing surface.

7. The wheel of claim 6, wherein the axle bore is sized such that narrow gaps are formed between the cylindrical hub bearing surfaces and the cylindrical axle bearing surfaces, and wherein as the wheel rotates, the lubricant flows through the axle bore into the narrow gaps for lubricating the cylindrical hub bearing surfaces and the cylindrical axle bearing surfaces.

8. The wheel of claim 7, wherein the central hub further comprises a plurality of agitating fins located within the lubricant reservoir, and wherein as the wheel rotates, the agitating fins agitate and circulate the lubricant within the lubricant reservoir.

9. The wheel of claim 1 further comprising a pair of bearings, wherein the bearings are secured to the axle and are received into and engage the axle bore for rotatably coupling the wheel to the axle, and wherein as the wheel rotates, lubricant flows through the axle bore to the bearings.

10. The wheel of claim 9, wherein the bearings are open-type tapered roller bearings.

11. The wheel of claim 1 further comprising a hub cap, wherein the axle bore comprises an outboard end, and wherein the hub secures to the central hub and encloses the axle bore outboard end.

12. The wheel of claim 11, wherein the hub cap is a cup-shaped member comprising a mounting flange, a cylindrical perimeter wall, a cap end wall, and a cap reservoir defined within the hub cap between the cap end wall and the cylindrical perimeter wall, wherein the mounting flange secures to the central hub, and wherein lubricant flows between the lubricant reservoir and the cap reservoir through the axle bore.

13. The wheel of claim 12, wherein cap end wall is constructed from a transparent material such that the condition and volume of the lubricant is visible through the cap end wall.

14. The wheel of claim 1 further comprising an annular gasket, wherein the axle bore comprises an inboard end, and wherein the annular gasket engages the axle and the central hub and seals the axle bore inboard end.

15. The wheel of claim 4 further comprising a pair of bearings, wherein the bearings are secured to the axle and are received into and engage the axle bore for rotatably coupling the wheel to the axle, and wherein as the wheel rotates, lubricant flows through the axle bore to the bearings.

16. The wheel of claim 15, wherein the bearings are open-type tapered roller bearings.

17. The wheel of claim 16 further comprising a hub cap, wherein the axle bore comprises an outboard end, and wherein the hub cap secures to the central hub and encloses the axle bore outboard end.

18. The wheel of claim 17 further comprising an annular gasket, wherein the axle bore comprises an inboard end, and wherein the annular gasket engages the axle and the central hub and seals the axle bore inboard end.

19. The wheel of claim 1, wherein the lubricant is an oil-based lubricant.

20. The wheel of claim 1, wherein the lubricant is a grease-based lubricant.
